(19) United States
(12) Patent Application Publication
(10) Pub. No.: US 2004/0001669 A1
(43) Pub. Date: Jan. 1, 2004

(54) Alignment switch with fiber stabilizing guide

(76) Inventors: Keyth M. Smith, Mission Hills, CA (US); Kishi A. Mitchell, Palmdale, CA (US); Trong-Huang Lee, Walnut, CA (US); Xiaoming Liu, La Palma, CA (US)

Correspondence Address: ELLIOTT N. KRAMSKY, Esq., Suite 400, 5850 Canoga Avenue, Woodland Hills, CA, 91367, US

(21) Appl. No.: 10/187,772

(22) Filed: Jul. 1, 2002

(51) Int. Cl. G02B 6/35

(52) U.S. Cl. 385/22

(57) ABSTRACT

An optical switch for selectively coupling the free end of an input fiber to the free ends of one of two output fibers includes a fiber stabilizing guide. Each of the output fibers is adhesively fixed within a v-groove of an output alignment block. The output alignment blocks are held in stacked relationship within a housing with their v-grooves upturned. An input alignment block having an inverted v-groove within its bottom surface is provided for guiding the input optical fiber, upon switching, toward engagement with the output fiber fixed to the upper output alignment block. A generally-planar fiber guide is fixed transverse to the arm of a two-position switch. The guide includes an internal rectangular aperture for receiving the input fiber whose width and height each exceed the diameter of the fiber. The guide is arranged so that the fiber is in contact with the bottom edge of the rectangular aperture when the state of the two-position switch makes optical connection between the input fiber and the output fiber fixed to the upper output alignment block and the input fiber is in contact with the top edge of the aperture with the input fiber is in optical contact with the output fiber fixed to the lower output alignment block.

### BACKGROUND

1. Field of the Invention

The present invention relates to switches for use in fiber optic communication networks. More particularly, this invention pertains to an optical switch for addressing multiple ports in a network that includes a fiber stabilizing guide.

2. Description of the Prior Art

Switches for coupling optical signals from an input fiber into one or more output fibers are required in numerous fiber optic communications systems. The effective coupling of optical signal energy between the cleaved end faces of optical fibers requires both proper longitudinal and axial alignment.

Switches of a mechanical nature require a device for physically moving the input fiber between positions of alignment of the input fiber with one of a number of output fibers. The need to minimize space within a mechanical switching system, as well as the relatively small diameter of the optical fiber, necessarily complicates the design of such a switch. The need for precise fiber alignment necessarily complicates the manufacture and cost of such an optical switch design.

U.S. Pat. No. 6,044,186 of Chin L. Chang et al. for “Fiber Optic Switching Apparatus and Method” teaches a switch of the above-described type. The patent teaches, inter alia, a 1×2 optical switch in which the two output fibers are held in headers that lie atop one another. Each header includes a surface v-groove into which one of the output fibers is seated and adhesively fixed. The two headers are arranged so that their v-grooves face one another, forming a diamond-shaped channel interior to the block formed by the headers. This arrangement mandates that a complex process be undertaken during manufacture for angular alignment of the cleaved free ends of the input and output fibers. First, the channel 2 (upper) output fiber is aligned end-to-end with the input fiber while positioned within the channel 2 (lower) v-groove that faces upwardly. A vacuum chuck that holds the channel 2 fiber is then rotated 180 degrees while the channel 1 output fiber is then aligned end-to-end with the input fiber. Upon alignment, the channel 1 fiber is fixed within the channel 1 v-groove of the lower header. The upper header is positioned, with the channel 2 v-groove facing downwardly, to receive the rotated channel 2 fiber which is fixed therein.

The above process, which follows from the geometry of the patented switch, requires that the precise position to which the channel 2 fiber has been aligned be held by the rotated vacuum chuck during alignment of the channel 1 fiber. This occasionally subjects the channel 2 fiber to misalignment as a consequence of the failure of the vacuum chuck to hold the radial orientation of the fiber. When detected, this will require the re-initiation of the entire alignment process, including the removal of the channel 1 fiber from the upwardly-facing v-groove in the lower header.

### SUMMARY OF THE INVENTION

The preceding and other shortcomings of the prior art are addressed by the present invention that provides, in a first aspect, an optical switch for selectively completing a light transmission path between an input fiber having a fiber diameter and one of a pair of output fibers. The optical switch includes a first and a second output alignment block. Each output alignment block is arranged to receive one of the output fibers and has a top surface and a bottom surface.

The output alignment blocks are arranged into a stack with the first alignment block below the second output block so that the top surface of the first output alignment block contacts the bottom surface of the second alignment block. Each output alignment block has a groove within its top surface for receiving an output fiber.

A two-position switch, actuable between a first state and a second state, has an arm. The state of the two-position switch is defined by the angular position of the arm. A fiber guide having an internal rectangular aperture comprising an aperture height and an aperture width is fixed to the arm for directing the free end of the input fiber toward the output fibers. The input fiber is responsive to the state of the two-position switch so that an optical path between the input fiber and the first output fiber is completed when the two-position switch is in the first state and an optical path is completed between the input fiber and the second output fiber when said two-position switch is in the second state.

In a second aspect, the invention provides an optical switch for selectively completing a light transmission path between an input fiber and one of a pair of output fibers. The optical switch includes a first and a second output alignment block, each arranged to receive one of the output fibers. Each output block has a top surface and a bottom surface and the output blocks are arranged into a stack with the first alignment block below the second output alignment block so that the top surface of the first output alignment block contacts the bottom surface of the second output alignment block.

Each of output alignment block has a v-groove within its top surface. The output fibers are adhesively fixed to the output alignment blocks within the v-grooves.

A two-position switch is actuable between a first state and a second state and has an arm, with the state of the switch defined by the angular orientation of the arm. A fiber guide has an internal rectangular aperture comprising an aperture height and an aperture width. The fiber guide is fixed to the arm for directing the free end of the input fiber toward the output fibers.

In a third aspect, the invention provides an optical switch for selectively completing a light transmission path between an input fiber and one of a pair of output fibers. The optical switch includes a first and a second output alignment block. Each output alignment block has a top surface and a bottom surface with a v-groove within the top surface of each of the output alignment blocks.

One of the output fibers is fixed within the v-groove of each alignment block. A two-position switch actuable between a first state and a second state is provided for guiding the input fiber between the first and second output fibers.

Each of the output alignment blocks, said input fiber and said output fibers is within a housing that includes (i) an opposed pair of generally-planar end panels, (ii) an opposed pair of generally-planar side panels and (iii) generally-planar top and bottom panels in opposed relation to one another. The output alignment blocks are fixed to the opposed side panels of the housing.

A fiber guide is provided that has an internal rectangular aperture comprising an aperture height and an aperture width. The said fiber guide is fixed to the arm of the two-position switch for directing the free end of the input fiber toward the output fibers.

The preceding and additional features and advantages of the invention will become further apparent from the detailed description that follows. Such description is accompanied by a set of drawing figures in which numerals, corresponding to those of the written description, point to features of the invention. Like numerals refer to like features of the invention throughout both the drawing figures and the written description.

### BRIEF DESCRIPTION OF THE DRAWINGS

FIGS. 1(a), 1(b) and 1(c) are a side sectional elevation view of an optical fiber alignment switch in accordance with the invention, a frontal view in detail of the fiber guide thereof taken at line 1(b)-1(b) of FIG. 1(a) and a diagrammatic view for illustrating design parameters associated with the fiber guide of the invention respectively;

FIG. 2 is a cross-sectional view of the optical fiber alignment switch of the invention taken at line 2-2 of FIG. 1(a) generally illustrating the output section of the switch;

FIG. 3 is a cross-sectional view of the optical fiber alignment switch of the invention taken at line 3-3 of FIG. 1 generally illustrating the input section of the switch;

FIGS. 4(a) and 4(b) are side and top views, respectively, that illustrate the alignment of input and lower output fibers in a switch in accordance with the invention; and

FIGS. 5(a) and 5(b) are side and top views, respectively, that illustrate the alignment of input and upper output fibers in a switch in accordance with the invention.

### DETAILED DESCRIPTION OF THE PREFERRED EMBODIMENT

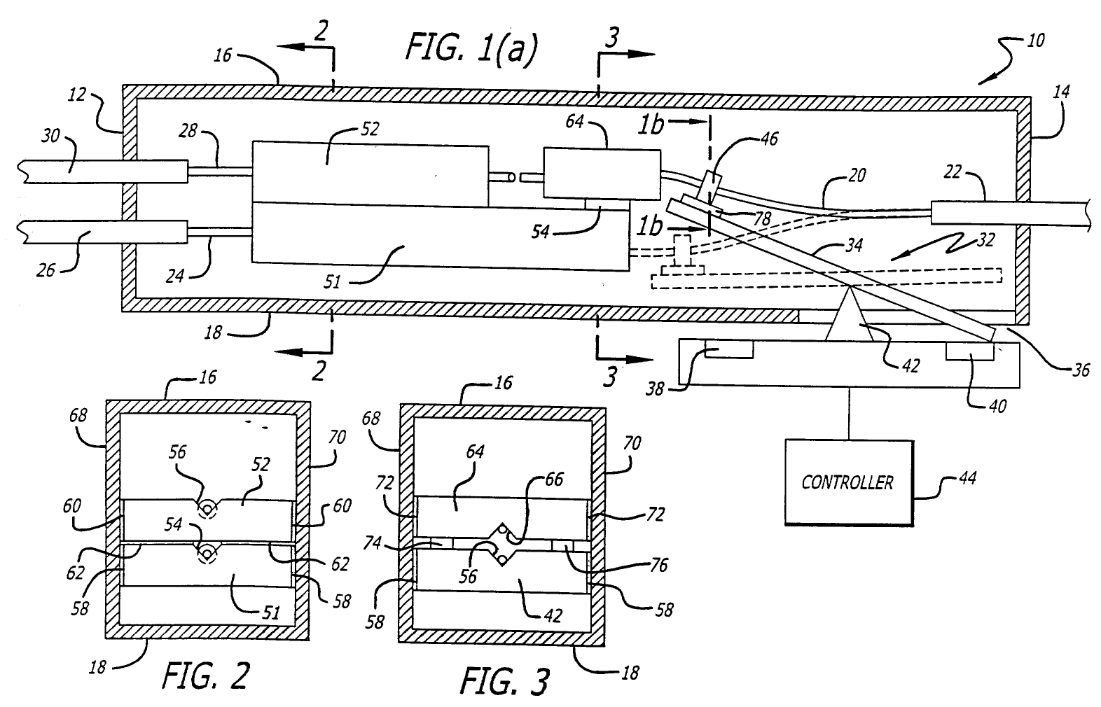

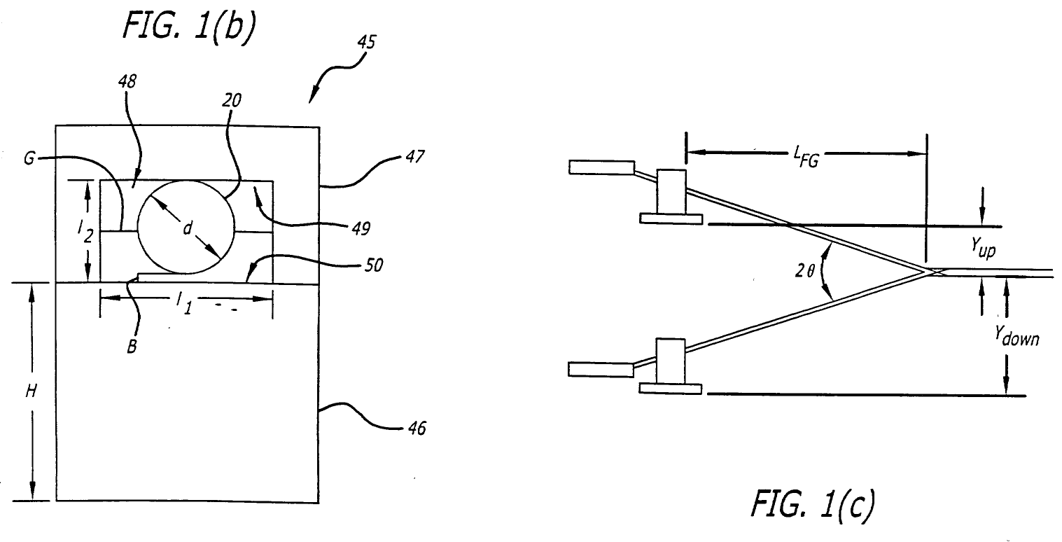

FIG. 1(a) is a side elevation view of an optical fiber alignment switch in accordance with the invention. The switch, which is enclosed within a housing 10, preferably of stainless steel and including planar end panels 12, 14, a planar top panel 16 and a planar bottom panel 18, selectively completes optical paths through an input fiber 20 (the free end of which has been stripped of an outer jacket 22) and a first output fiber 24 (whose outer jacket 26 has been stripped) or through the input fiber 20 and a second output fiber 28 (stripped of an outer jacket 30).

A relay 32 is arranged to switch the input fiber 20 between alignment with the first and second output fibers 24 and 28. Such relay 32 may comprise a conventional electromechanical device that includes an arm 34 that protrudes into the interior of the housing 10 through an opening 36 in the bottom panel 18. The angular position of the arm 34 affects the position of the free end of the input fiber 20 and, hence, its longitudinal alignment with one or the other of the output fibers 24 and 28. Such angular positioning of the arm 34 is responsive to the energization of electromagnets 38 and 40 that are spaced at opposite sides of a pivot 42 that supports the arm 34. The selective energization of the electromagnets 38 and 40 is accomplished by means of a controller 44. The controller 44 may be programmable for affecting a particular sequencing of the optical connections between the input fiber 20 and the output fibers 24 and 28. Alternately, the controller 44 may responsive either to a manual or machine-generated input signal.

A two-part fiber guide 45 is fixed to the arm 34 of the relay 32. The guide 45, as illustrated in detail in FIG. 1(b), permits fiber slippage while guiding the free end of the input fiber 20 toward longitudinal alignment with either of the output fibers 24 or 28.

The guide 45, which may, for example, be of copper, brass or aluminum fabrication, consists of a base 46 and a top 47 which, when joined together, form an internal aperture 48 of generally-rectangular shape. Both the width l₁ and the height l₂ of the internal aperture 48 exceed the diameter d of the input fiber 20. The internal aperture is carefully dimensioned and located along the arm 34, so that its upper edge 49 contacts the input fiber 20 when the input fiber 20 is guided to optical contact with the (lower) output fiber 24 while its lower edge 50 contacts the input fiber 20 when the input fiber 20 is guided into optical contact with the (upper) output fiber 28. In this way, the fiber guide 45 provides maximum up-and-down guidance to the input fiber 20 in response to the state of the two-position switch 32 while freeing the input fiber 20 from undesired side-to-side displacements due to the wobbling of the arm 34. Such side-to-side displacements could otherwise result in misalignment of the input fiber with one or both of the output fibers.

An analysis of the design of the fiber guide 45 for operation as above-described follows. The relationships between the various design parameters, involving both the dimensions of the fiber guide 45 and its placement with respect to the arm 34, are illustrated in FIGS. 1(b) and 1(c). As shown in the two figures, the design parameters include the following:

H=height of the base 46;

W=average amplitude of side-to-side wobble of the relay arm 34;

B=difference between the diameter of the input fiber 20 and the height 12 of the internal aperture 48;

G=difference between the diameter of the input fiber 20 and the width l₁ of the aperture 48 (each side of input fiber 20);

L_{FG}=distance of the guide 45 from the pivot point 42;

Yᵤₚ=relative up position of the guide 45 with reference to the housing;

Y_{down}=relative down position of the guide 45 with reference to the housing; and

θ=angle between the neutral position (horizontal) and each of the up and down positions of the input fiber 20.

Referring to FIGS. 1(b) and 1(c), the following set of equations define the critical design parameters G, H and B of a solution that yields the performance characteristics described above:

G=W (1)

H=L_{FG} sin θ−Yᵤₚ (2)

B=Y_{down}−L_{FG} sin θ−H (3)

In forming the fiber guide 45, the base 46 is made of shims of a predetermined height and fixed to he arm 34 by means of UV and thermal EPOXY. The input fiber 20 should not touch the base 46. The top 47 is then placed on top of the base 46 and the input fiber 20 located therein with clearings a distance G from both sides of the horizontal aperture 48. UV and thermal EPOXY is preferably utilized to fix the top 47 to the base 46 of the guide 45.

The switch is arranged for ready longitudinal alignment of the cleaved ends of the optical fiber pairs 20 and 24 or 20 and 28. Angular alignment of the cleaved end faces of fiber pairs is accomplished during manufacture (discussed below). Such angular alignment is facilitated by the fixing of the output fibers 24 and 28 to first and second output alignment blocks 51 and 52 respectively. Each of the output alignment blocks includes a central v-groove (not shown in FIG. 1(a)) for accommodating the associated fiber. The v-grooves of the output alignment blocks 51 and 52 face upwardly to permit a straightforward sequential process of alignment of the fiber pairs 20 and 24 and 20 and 28 respectively. This is in contrast to the teachings of U.S. Pat. No. 6,044,186 in which v-grooves for securing output fibers are arranged as mirror images of one another. Such a geometry requires the alignment of one of the fibers in the v-groove for holding the other fiber followed by its rotation through 180 degrees prior to fixing to its proper header and v-groove, a process that is subject to failure, requiring repetition of steps and consequent increase in cost of manufacture.

FIG. 2 is a cross-sectional view taken at line 2-2 of FIG. 1 for illustrating the output portion of the switch. The v-grooves 54 and 56 within the upper surfaces of the glass output alignment blocks 51 and 52 respectively are apparent in this view. In addition, it can be seen that each of the blocks 51, 52 is fixed to the interior of parallel side walls of the housing 10 by layers of adhesive (preferably uv and thermal EPOXY) 58 and 60 respectively. The blocks 51 and 52, which are maintained in a stacked, contacting relationship, are additionally fixed to one another at their contacting surfaces by means of an additional layer of adhesive 62, preferably EPOXY.

Returning to FIG. 1(a), an input alignment block 64 serves to guide the input fiber 20 into alignment with the second output fiber 28. FIG. 3 is a cross-sectional view taken at line 3-3 of FIG. 1 and illustrating the input portion of the switch. Unlike the output alignment blocks 51 and 52, the central v-groove 66 of the input alignment block 64 is inverted. As in the case of the output headers, the input alignment block 64 is fixed to the interior of planar side walls 68, 70 of the housing 10 by means of layers of adhesive 72, preferably EPOXY. Shims 74 and 76 prevent the first output alignment block 51 from directly contacting the input alignment block 64 while maintaining the top of the inverted v-groove 66 at the precise height for guiding the bare input fiber 14 into alignment with the second output fiber 28. Any need for the shims 74, 76 could, of course, be circumvented by increasing the height of the input alignment block 64 and the depth of the v-groove 66.

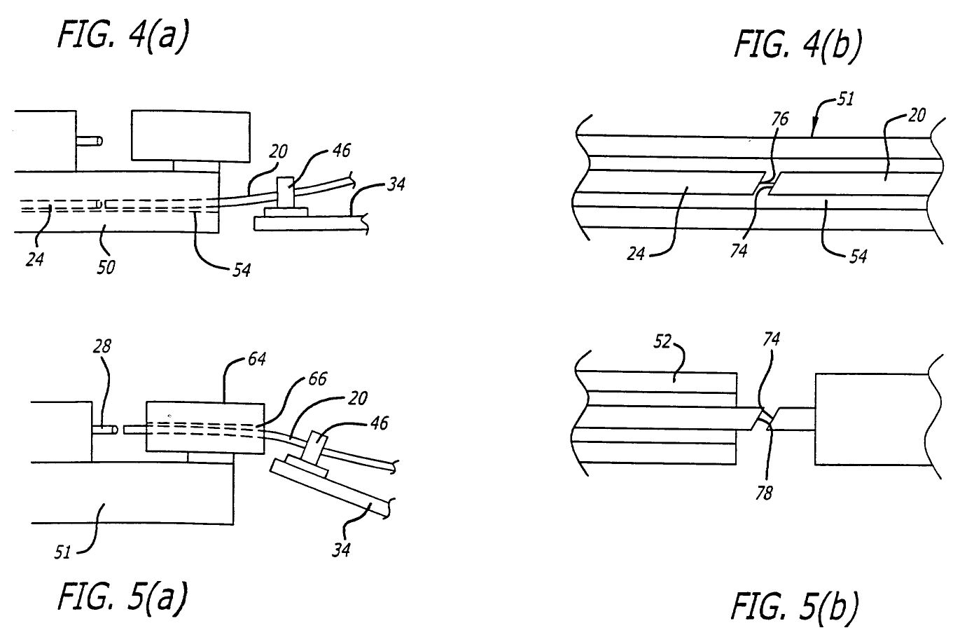

FIGS. 4(a) and 4(b) are side elevation and top planar views, respectively, for illustrating the switch configuration for aligning the input fiber 20 with the first output fiber 24. As can be seen, the arm 34 of the relay 32 has been switched to a downward orientation. As a result, the input fiber 20, which is directed by the fiber guide 46, is thereby inclined downwardly and pushed to the bottom of the v-groove 54 of the first output alignment block 51. Striking the bottom of the v-groove 54 at an angle, the free end of the input fiber 20 gradually settles to the bottom of the v-groove 54 with the adjacent portion of the fiber 20 traveling horizontally adjacent the region of coupling to the first output fiber 24. As seen in FIG. 4(b), the cleaved ends 74, 76 of the fibers 20 and 24 respectively, having undergone an angular alignment process during switch fabrication (discussed below), are now in position to transfer sufficient optical signal power to complete satisfactory connection therebetween. In practice, a goal of 75 dB transfer of energy has been applied.

FIGS. 5(a) and 5(b) are side elevation and top plan views, respectively, that illustrate the configuration of the switch while mating the input fiber 20 and the second output fiber 28. In these views, one can see that the input fiber 20, having been raised by rotation of the relay arm 34, is gradually guided to a horizontal attitude by the v-groove 66 of the input alignment block 64 in much the same way that it was guided by the v-groove 54 of the first output alignment block 51 as illustrated in FIG. 4(a). As a result, upon emergence of the free end of the input fiber 20 from the block 64 proper longitudinal alignment with the second output fiber 28 is obtained.

As discussed above, FIG. 5(b) shows that, when axial alignment of the fibers 20 and 28 is obtained, radial alignment of the fibers follows. This is evidenced by the parallel cleaved output faces 74, 78 of the fibers 20 and 28 respectively. Such radial alignment of fibers is achieved in a straightforward manner and is facilitated by the arrangement of the present invention.

While the discussion of the invention has concentrated upon the achievement of longitudinal alignment between the input fiber 20 and the output fibers 24 and 28, effective optical connection also requires, and the design of the invention facilitates, angular alignment of the cleaved fiber ends. As mentioned earlier, the design of the 1×2 switch disclosed in U.S. Pat. No. 6,044,186 demands a complex fabrication process due to the facing arrangement of v-grooves for retaining the output fibers. In the present invention, the v-grooves of output alignment blocks 51 and 52 are parallel to one another and the required access of the free end of the input fiber 20 to the free ends of the output fibers 24 and 28 is achieved by a design in which (1) the length of the upper output alignment block 52 is less than that of the lower output alignment block 51 and (2) the free end of the upper output fiber 28 extends beyond the upper output alignment block 52.

The fabrication of the invention does not require the complex process required in the referenced patent for angularly aligning the cleaved ends of the output fibers. In the invention, angular alignment of the cleaved free ends of the fibers are achieved by first switching the relay 32 to the down position so that the input fiber 20 lies in the v-groove 54 of the lower output alignment block 51. The first output fiber 24 is then moved into the v-groove 54 so that its free end is close to that of the input fiber 20. The fiber 24 is then rotated so that the angle of its cleaved end matches that of the input fiber 20 with the degree of angular alignment evaluated by transmitting an optical signal through the coupled fibers and measuring the degree of transmission (0.75 dB or better sought). Once angular alignment is achieved, the input fiber 20 is adhesively fixed to the end panel 14 of the housing 10, the shim 48 and fiber guide 46 are fixed to the arm 34 and the relay 32 switched up and down to make sure the input fiber 20 is straight. The lower output fiber 24 is then adhesively fixed to the v-groove 54 and to the end panel 12 of the housing 10.

The upper output alignment block 52 is then set atop the lower output alignment block 51 with a 5 micron from the cleaved free end of the first output fiber 24 to the edge of the lower output alignment block 51 followed by putting UV EPOXY on the corner of the v-groove 56 and thermal EPOXY along the side of the v-groove 56 side panels 68, 70 of the housing 10.

The second output fiber 28 is then placed into the v-groove 56 with the cleaved free end of the fiber 28 overhanging the edge of the upper output alignment block 52 by about 50 microns. The relay 32 is switched to the up position and the input alignment block 64 and v-groove 66 placed over the input fiber 20, bringing the free end of the input fiber 20 down and into longitudinal alignment with the second output fiber 28. The second output fiber 28 is then rotated to obtain angular alignment with the input fiber 20. Once 0.75 dB or better (with a 10 micron gap between the cleaved ends of the fibers 20 and 28) uv and thermal EPOXY are then applied to the second output fiber 28 and the fiber 28 is adhesively fixed to the v-channel 56.

Once the fixation of the second output fiber 28 to the v-channel 56 is completed, the input alignment block 64 is removed and the shims 74 and 76 installed at either side of the v-groove 54 within the lower output alignment block 51. The input alignment block 64 is then re-installed within the housing 10 above the input fiber 20, bringing its free end back into longitudinal alignment with the second output fiber 28. Once 0.75 dB or better is obtained, UV and thermal EPOXY is applied and the lower output alignment block 51 and the input alignment block 64 fixed to the side panels 68, 70 of the housing 10.

Once the above processes have been completed, both angular and longitudinal alignment is obtained between the input fiber 20 and each of the output fibers 24 and 28 in an optical switch in accordance with the invention. As can be seen, such alignment is obtained without any need to remove and rotate an output fiber by 180 degrees after initial alignment, then to hold the rotated fiber aside in a vacuum chuck while the other output fiber undergoes alignment. By providing a switch design and arrangement in accordance with the invention one obtains a device that is more suitable to manufacture and economical than that of the referenced patent.

While this invention has been disclosed with reference to its presently-preferred embodiment, it is not limited thereto. Rather, this invention is limited only insofar as it is defined by the following set of patent claims and includes within its scope all equivalents thereof.

What is claimed is:

1. An optical switch for selectively completing a light transmission path between an input fiber having a fiber diameter and one of a pair of output fibers comprising, in combination:
a) a first and a second output alignment block, each of said output alignment blocks being arranged to receive one of said output fibers;
b) each of said output alignment blocks having a top surface and a bottom surface;
c) said output alignment blocks being arranged into a stack with the first alignment block below the second output block so that the top surface of the first output alignment block contacts the bottom surface of the second alignment block;
d) each of said output alignment blocks having a groove within its top surface for receiving an output fiber;
e) a two-position switch actuable between a first state and a second state;
f) said two-position switch having an arm, the state of said switch being defined by the angular position of said arm;
g) a fiber guide having an internal rectangular aperture comprising an aperture height and an aperture width, said fiber guide being fixed to said arm for directing the free end of said input fiber toward said output fibers; and
h) said input fiber being responsive to the state of said two-position switch so that an optical path between said input fiber and said first output fiber is completed when said two-position switch is in said first state and an optical path is completed between said input fiber and said second output fiber when said two-position switch is in said second state.

2. An optical switch as defined in claim 1 wherein each of said grooves is a v-groove.

3. An optical switch as defined in claim 2 wherein each of said fibers is adhesively fixed to the v-groove of an associated output alignment block.

4. An optical switch as defined in claim 1 wherein each of said output alignment blocks, said input fiber and said output fibers is within a housing.

5. An optical switch as defined in claim 4 wherein said housing further includes:
a) an opposed pair of generally-planar end panels;
b) an opposed pair of generally-planar side panels; and
c) generally-planar top and bottom panels in opposed relation to one another.

6. An optical switch as defined in claim 5 wherein said output alignment blocks are fixed to said opposed side panels of said housing.

7. An optical switch as defined in claim 6 wherein said output alignment blocks are spaced above said bottom panel of said housing.

8. An optical switch as defined in claim 3 further characterized in that:
a) the free end of said output fiber fixed to said first alignment block being spaced from an end of said first alignment block; and
b) the free end of said output fiber fixed to said second alignment block extending beyond an end of said second alignment block.

9. An optical switch as defined in claim 8 further including:
a) an input alignment block;
b) said input alignment block having a top surface and a bottom surface; and
c) said input alignment block having a groove within its bottom surface for guiding said input fiber into longitudinal alignment with said output fiber fixed to said second alignment block.

10. An optical switch as defined in claim 9 further characterized in that said groove within the bottom surface of said input alignment block is an inverted v-groove.

11. An optical switch as defined in claim 1 wherein the height and the width of said aperture each exceed the diameter of said input fiber.

12. An optical switch as defined in claim 1 further characterized in that said fiber guide is substantially planar and fixed transverse to the length of said arm.

13. An optical switch as defined in claim 12 wherein:
a) said arm is rotatable about a pivot; and
b) said fiber guide is fixed intermediate the portion of the length of said arm between said pivot and an end of said arm.

14. An optical switch as defined in claim 1 wherein:
a) said aperture includes a top edge and a bottom edge, each being equal in length to the width of said aperture; and
b) said fiber guide is arranged so that said input fiber contacts the bottom edge of said aperture when said input fiber is in optical contact with one of said output fibers and contacts said top edge of said aperture when said input fiber is in optical contact with the other of said output fibers.

15. An optical switch for selectively completing a light transmission path between an input fiber and one of a pair of output fibers comprising, in combination:
a) a first and a second output alignment block, each of said output alignment blocks being arranged to receive one of said output fibers;
b) each of said output blocks having a top surface and a bottom surface;
c) said output alignment blocks being arranged into a stack with the first alignment block below the second output alignment block so that the top surface of the first output alignment block contacts the bottom surface of the second output alignment block;
d) each of said output alignment blocks having a v-groove within its top surface;
e) said output fibers adhesively fixed to each of said output alignment blocks within a v-groove;
f) a two-position switch actuable between a first state and a second state, said two-position switch having an arm, the state of said switch being defined by the angular orientation of said arm; and
g) a fiber guide having an internal rectangular aperture comprising an aperture height and an aperture width, said fiber guide being fixed to said arm for directing the free end of said input fiber toward said output fibers.

16. An optical switch as defined in claim 15 further characterized in that:
a) the free end of said output fiber fixed to said first alignment block being spaced from an end of said first alignment block; and
b) the free end of said output fiber fixed to said second alignment block extending beyond an end of said second alignment block.

17. An optical switch as defined in claim 15 further including:
a) an input alignment block;
b) said input alignment block having a top surface and a bottom surface; and
c) said input alignment block having an inverted v-groove within its bottom surface for guiding said input fiber into longitudinal alignment with said output fiber fixed to said second alignment block.

18. An optical switch as defined in claim 15 wherein the height and the width of said aperture each exceed the diameter of said input fiber.

19. An optical switch as defined in claim 15 further characterized in that said fiber guide is substantially planar and fixed transverse to the length of said arm.

20. An optical switch as defined in claim 19 wherein:
a) said arm is rotatable about a pivot; and
b) said fiber guide is fixed intermediate the portion of the length of said arm between said pivot and an end of said arm.

21. An optical switch as defined in claim 15 wherein:
a) said aperture includes a top edge and a bottom edge, each being equal in length to the width of said aperture; and
b) said fiber guide is arranged so that said input fiber is in contact with the bottom edge of said aperture when said input fiber is in optical contact with one of said output fibers and is in contact with the top edge of said aperture when said input fiber is in optical contact with the other of said output fibers.

22. An optical switch for selectively completing a light transmission path between an input fiber and one of a pair of output fibers comprising, in combination:
a) a first and a second output alignment block, each of said output alignment blocks having a top surface and a bottom surface with a v-groove within the top surface of each of said output alignment blocks;
b) one of said output fibers being fixed within the v-groove of each of said output alignment blocks;
c) a two-position switch actuable between a first state and a second state for guiding said input fiber between said first and second output fibers;
d) each of said output alignment blocks, said input fiber and said output fibers being within a housing including (i) an opposed pair of generally-planar end panels, (ii) an opposed pair of generally-planar side panels and (iii) generally-planar top and bottom panels in opposed relation to one another;
e) said output alignment blocks being fixed to said opposed side panels of said housing; and
f) a fiber guide having an internal rectangular aperture comprising an aperture height and an aperture width, said fiber guide being fixed to said arm for directing the free end of said input fiber toward said output fibers.

23. An optical switch as defined in claim 22 further including:
a) an input alignment block;
b) said input alignment block having a top surface and a bottom surface; and
c) said input alignment block having an inverted v-groove within its bottom surface for guiding said input fiber into longitudinal alignment with said output fiber fixed to said second alignment block.

24. An optical switch as defined in claim 23 wherein said input alignment block is fixed to opposed side panels of said housing.

25. An optical switch as defined in claim 22 further characterized in that:
a) the free end of said output fiber fixed to said first alignment block being spaced from an end of said first alignment block; and
b) the free end of said output fiber fixed to said second alignment block extending beyond an end of said second alignment block.

26. An optical switch as defined in claim 25 further including:
a) said two-position switch having an arm, the state of said switch being defined by the angular position of said arm; and
b) a fiber guide fixed to said arm for directing the free end of said input fiber toward said output fibers.

27. An optical switch as defined in claim 22 wherein the height and the width of said aperture each exceed the diameter of said input fiber.

28. An optical switch as defined in claim 22 further characterized in that said fiber guide is substantially planar and fixed transverse to the length of said arm.

29. An optical switch as defined in claim 28 wherein:
a) said arm is rotatable about a pivot; and
b) said fiber guide is fixed intermediate the portion of the length of said arm between said pivot and an end of said arm.

30. An optical switch as defined in claim 22 wherein:
a) said aperture includes a top edge and a bottom edge, each being equal in length to the width of said aperture; and
b) said fiber guide is arranged so that said input fiber is in contact with the bottom edge of said aperture when said input fiber is in optical contact with one of said output fibers and is in contact with the top edge of said aperture with said input fiber is in optical contact with the other of said output fibers.
